(19) United States
(12) Patent Application Publication
(10) Pub. No.: US 2012/0056996 A1
(43) Pub. Date: Mar. 8, 2012

(54) SPECIAL-ILLUMINATION SURGICAL VIDEO STEREOMICROSCOPE

(75) Inventors: ULRICH SANDER, Rebstein (CH); HERBERT STÜTTLER, Au (CH)

(73) Assignee: LEICA MICROSYSTEMS (SCHWEIZ) AG, HEERBRUGG (CH)

(21) Appl. No.: 13/224,417

(22) Filed: Sep. 2, 2011

(30) Foreign Application Priority Data
Sep. 6, 2010 (DE) 10 2010 044 502.9

(51) Int. Cl. H04N 13/02

(52) U.S. Cl. 348/47; 348/E13.074

(57) ABSTRACT

A special-illumination surgical video stereomicroscope having at least one light source for illuminating an in-situ specimen, at least one video imaging unit (104a) being provided for acquiring a fluorescence image of the specimen, the spectral sensitivity of the at least one video imaging unit (104a) exhibiting a higher spectral sensitivity in at least one light wavelength region of a special light radiation to be expected, e.g. fluorescence radiation, than in another light wavelength regions.

### CROSS REFERENCE TO RELATED APPLICATIONS

This application claims priority of German patent application number 10 2010 044 502.9 filed Sep. 6, 2010, the entire disclosure of which is incorporated by reference herein.

### FIELD OF THE INVENTION

The present invention concerns a special-illumination surgical video stereomicroscope for detecting and assisting the treatment of areas of a specimen in an object field.

### BACKGROUND OF THE INVENTION

The standard fluorescence microscopes that are usual nowadays operate on the incident light principle. This means that the specimen is illuminated from above through the objective, which functions simultaneously as a condenser. Very high-pressure mercury vapor lamps with an output of between 50 and 400 W, or xenon lamps of corresponding performance, are usually used today as an illumination device (which must contain the excitation wavelength of the selected fluorochrome). These lamps supply a broad spectrum of usable wavelengths between 360 nm and 700 nm. The excitation wavelength of the selected fluorochrome is firstly filtered out of the overall illumination spectrum by means of an input bandpass filter (excitation filter). The excitation wavelength travels to a dichroic beam splitter, which reflects the short-wavelength excitation light and at the same time is transparent to the longer-wave light of the emitted radiation. The excitation radiation travels through the objective onto the specimen and excites the fluorochrome, which then emits longer-wavelength light. This passes through the dichroic beam splitter and arrives at the output blocking filter (emission filter), which filters the desired emission wavelength of the fluorochrome (the actual fluorescence image). The fluorescence image can either be viewed through the eyepiece or recorded using a photographic or video camera.

DE-A-102 52 313 is a member of the same family (priority application) as US-A-2004 152987 cited in the granting process for EP-A-1 691 229. It, too, indicates the specialized knowledge of one skilled in the art regarding the interaction of excitation, fluorescence, and observation. What is special therein is that, for contrast adaptation, the excitation filter is modified or its transmittance is varied, for example by way of a liquid crystal filter.

DE 10 2008 062 650 refers to a surgical microscope for observing an infrared fluorescence. The known microscope encompasses a camera system having a three-chip camera. The individual chips of the camera serve to detect light of different wavelengths. In order to enable a measurement of light components of different wavelengths using chips of inherently similar construction, the light is spectrally divided by means of a dichroic beam splitter before arriving at the surface of the chip, and the divided light is conveyed to chips of inherently similar construction.

US-A1-2009/0190209 describes a simplified stereoscopic imaging unit having a simplified stereoscopic image reproduction unit. A single video chip is located in an image plane and is impinged upon simultaneously by the stereoscopic microscope image made up of two stereoscopic partial images arranged in parallel. The electronic image is further processed as a single video frame, and depicted on a display. The left and right stereoscopic partial images are thus reproduced simultaneously on this display. Suitable eyepiece beam paths enable stereoscopic observation for an observer. This known system offers no assistance for the observation of specimens under special illumination.

### SUMMARY OF THE INVENTION

The invention initially relates and is confined to a combination of all these microscope types into one stereoscopic and microscopic video beam path that serves on the one hand for surgery and on the other for special-illumination observation, e.g. fluorescence observation, for which reason the filter devices (e.g. working, excitation and observation filters, and the video imaging units according to the present invention to be indicated later) that are present are, in such surgical microscopes, selectably insertable and/or deactivatable and/or removable.

The present disclosure is to be construed broadly, so that other magnification apparatuses such as, for example, endoscopes or laparoscopes are also embraced thereby, provided they serve equally for surgery and for special-illumination observation and are usable correspondingly.

The manner of operation of fluorescence microscopy and the effect of fluorescence on tissue are known to one skilled in the art (see e.g. U.S. Pat. No. 6,510,338, col. 1, lines 38-49 and 60-62). He or she is also well informed as to the basic configuration in which usually one illumination device having a large bandwidth (white light) is used in principle to make available light in the fluorescence excitation region for fluorescence excitation (U.S. Pat. No. 6,510,338, col. 2, lines 32-33 and Claim 1, lines 4-5 and Claim 4, lines 54-55). A filter system is used here, having an excitation filter in the illumination beam path and an observation filter in the observation beam path. Selection of the filters, and the purpose thereof in combination with or relation to one another, are also known to one skilled in the art and are reproduced in said publication U.S. Pat. No. 6,510,338. Of the broad-band light of the illumination device, the excitation filter allows transmission, and arrival at the object field, of only that light which excites fluorescence there. The observation filter then in turn blocks the excitation light and allows chiefly only the light of the fluorescence phenomenon to pass. (These are all old principles of fluorescence microscopy: U.S. Pat. No. 6,510,338, col. 2, lines 38-49). The drawings of U.S. Pat. No. 6,510,338 and description of the figures thereof also support these statements (U.S. Pat. No. 6,510,338, col. 6, lines 4-9).

DE-A-195 48 913 also contains similar indications as to fluorescence observation or photodynamic diagnosis (PDD) using white light (at least 370 to 780 nm), an excitation filter in the illumination beam path, and an observation filter in the observation beam path for the fluorescence spectrum (see DE-A-195 48 913, Abstract and col. 3, lines 3-14).

EP-A1-1 691 229 discloses an illumination device that is assembled from two different illumination devices that are to be used together in order to act respectively in light-intensifying fashion. Because both illumination devices are to be used in order to intensify one another in the context of fluorescence excitation illumination, however, it is disclosed that that spectral region of the light spectrum which both illumination devices fundamentally and obligatorily have in common, is the fluorescence excitation region. The region width of the two spectral regions may be, and in accordance with EP-A1-1 691 229 is intended to be, different, provided they nevertheless have the fluorescence excitation region in common. For red-light fluorescence, the second illumination device is therefore preferably optimized to radiate in the region of red to IR light; for blue-light fluorescence on the other hand, according to this existing art, the second illumination device will be more heavily weighted in the blue-light to UV spectral region, while the first illumination device is optimized for white light. In the context of the present invention, however, there appears for such surgical fluorescence video stereomicroscopes a further, inventively novel third combination possibility explained below, namely the combination of a blue/UV-optimized illumination device with a red/NIR- or IR-optimized illumination device which, when they are operated together, optionally by means of illumination filters, combine to yield an optimized white light illumination device.

For the construction according to the present invention of the present patent application, it is open and encompassed in equivalent fashion in terms of the range of protection of the main claim, regardless of whether the light derives from a light source, an illumination source, an illumination element, a single illumination device, or multiple illumination devices.

The invention relates to a special-illumination surgical video stereomicroscope, for example corresponding to the one according to US-A1-2009/0190209, which, however, in contrast to said known device, is equipped to detect and assist the treatment of specific areas of an object field that are poorly visible under white light. It encompasses a video observation beam path in whose image plane a spectrally sensitive (color) video imaging unit is arranged, as is known per se.

In the surgical microscopy sector it is becoming increasingly necessary to make preoperative data about the patient visible to the surgeon or the user in the observation beam path of the microscope. New diagnostic data are, however, also continuously required during the procedure, since the surgical site may likewise constantly change. These include, for example, NMR data, which are extremely difficult to obtain during surgery on an anesthetized patient. It would likewise be desirable, for example when utilizing the fluorescence technique, to be able to continuously monitor changes in the surgical site after actions have been taken.

Tissue-diagnostic data (tissue differences in terms of their biological and/or visual properties) are therefore to be obtained largely with optoelectronic methods using the novel special-illumination surgical video stereomicroscope, and injected for the surgeon, during the operation, into the special-illumination surgical video stereomicroscope or into its visual observation beam path for diagnostic assessment. The diagnostic methods principally disclosed in this context have been those based on false-color depictions or fluorescence depiction of tumor tissue, as indicated above. A special-illumination surgical fluorescence video stereomicroscope of this kind has been disclosed, for example, by DE-A1-102005 005 984.

US-A1-2009/0190209 describes a surgical video stereomicroscope that encompasses a first binocular surgical stereomicroscope having a visual observation beam path having eyepieces and a first display, which is arranged to be capable of three-dimensional relative displacement with respect to the binocular surgical stereomicroscope. The display encompasses a binocular display/observation beam path and a unitary display on which the left part of the display depicts monoscopic image data from a stereoscopic left partial observation beam path, while the right part of the display displays monoscopic image data from a stereoscopic right partial observation beam path. These partial observation beam paths are imaged by a stereoscopic video imaging unit in the image plane of a video observation beam path. What is special about this existing art is on the one hand that the video observation beam path (FL2, FR2) is rotated 90 degrees relative to the visual observation beam path (FL, FR) (see FIG. 6 of US-A1-2009/0190209), and on the other hand that both the video chip of the stereoscopic imaging unit and the aforementioned display are embodied unitarily, so that right and left stereoscopic partial-image data are electronically processed simultaneously, and separate electronic treatment of left and right partial beam paths is omitted. Processing of the video signals thus does not occur (as was usual previously) in time-sequential fashion, nor does it occur in color-coded and simultaneous fashion, depicted in integrated fashion on the same display. It occurs by way of a single (monoscopic) video image signal, by the fact that the left and right image plane of the left and right video observation beam path are imaged on a single unitary video chip, physically separately next to one another. The video chip of the video imaging unit is thus unitary in terms of the left and right partial video observation beam paths, but is arranged so that the left partial image data from the stereoscopic video observation beam path is imaged on its left half, and the right partial image data on its right half Corresponding to this, the 3D image is depicted on the unitary display in such a way that the single electronically available video signal is depicted, after any electronic processing, on the unitary display, so that on the display as well, the left half pertains to the left partial video observation beam path, and the right half to the right partial video observation beam path.

A particular embodiment of the invention also makes use of this 3D imaging and reproduction technology. It is not, however, limited thereto. In particular, the video chip can be divided into two imaging chips (one for the right and one for the left partial video observation beam path), and the display can be, as is known per se, embodied in two parts, so that an individual (and inherently monoscopic) display is allocated to each observer eye, and it is only the simultaneous viewing of the two monoscopic images of the display that produces a 3D image for the observer.

Conventional diagnostic methods, based on fluorescent depiction of tumor tissue, require very high illumination intensities in the spectral regions around 400 nm or around 800 nm, which often are produced by means of additional illumination devices that, in the spectral region from 400 to 800 nm, could unnecessarily stress and in some cases even damage the patient. Complex measures must be taken to prevent this damage.

It is therefore an object of the invention to simplify these requirements, and to implement them with the simplest possible means in a relevant special-illumination surgical video stereomicroscope.

This object is achieved according to the present invention, with a special-illumination surgical video stereomicroscope of the kind cited initially, by the fact that at least one video imaging unit is provided for acquisition of an image of the object field, and thus optionally also for acquisition of the image, generated by means of special illumination (e.g. fluorescence image), of the specimen in the object field, the spectral sensitivity of which unit exhibits, in at least one light wavelength region of a light to be expected from the object field (e.g. emitted or reflected light, for example fluorescence emission radiation and reflected background radiation), a greater spectral sensitivity than in other light wavelength regions.

According to the present invention, the spectral sensitivity of the video imaging unit, in particular of a video camera, preferably a stereo video camera, is designed in accordance with the desired selective spectral regions, in particular in accordance with the special illumination conditions (e.g. fluorescence conditions), differently for the right and the left partial image. With this novel video camera technology according to the present invention, in which the right and left video chip halves of a single video chip have different properties, the disadvantages of the existing art are eliminated and a simple surgical video microscope is created that, with the use of specific illumination (special illumination), makes areas in the object field particularly easily visible. As already mentioned, in a variant of the invention a separate video chip can also be provided for each partial beam path. According to this embodiment of the present invention the two video chips are designed spectrally differently from one another, in order to account correspondingly for the special illumination and for any spectral effects in or arising from the object field. The unitary video chip, which acquires in a single video frame both the right and the left partial image, is nevertheless preferred.

According to the present invention, thanks to high sensitivity in preferred spectral regions it is possible to reduce the light impact on the patient as a result of the illumination device of the surgical video stereomicroscope. The inventive idea makes possible overall, without complex additional devices such as diagnostic or measurement devices, a depiction that has low impact on the patient as well as intraoperative distinction of diseased tissue. This is accompanied by a decrease in the energy consumption of the surgical video stereomicroscope according to the present invention, and thus also a decrease in the thermal stress in the environment of the surgical video stereomicroscope. This is advantageous not only for the patient but also for the surgeon and other OR personnel.

Entirely apart from this, the video imaging unit is, when correspondingly designed, more photosensitive than the human eye in the respective desired light wavelength regions between UV and IR. It is thus possible also to acquire video information, and display it to the user e.g. via false-color depictions, that was hitherto unavailable to that user. This relates in particular to emission phenomena in the NIR/IR or UV (or UV-vicinity) region. The latter phenomena are not only poorly visible to the observer, but also in some circumstances even damaging, and in fact have hitherto been deliberately absorbed (i.e. made invisible) by filtration.

The invention thus improves, in many ways, the convenience and efficiency of a conventional surgical video stereomicroscope.

In order to achieve a contrast improvement, the video imaging unit can comprise at least one video chip, in particular a CCD or CMOS video chip, upstream from which an observation filter is placed at least in the left and/or right partial video observation beam path in order to allow transmission, substantially unattenuated, of at least one of the light wavelength regions of the expected emitted radiation simultaneously with (partial) absorption of other light wavelength regions.

Alternatively, the filters provided in the context of conventional video chips can be removed so that the latter can be fully utilized with their original spectral sensitivity.

Alternatively, for contrast improvement, the video imaging unit can also comprise at least one video chip, in particular a CCD or CMOS, whose spectral sensitivity in at least one light wavelength region emitted from the excited site in the object field is elevated, as compared with other light wavelength regions, by doping.

In order to enable information about the specially illuminated, e.g. fluorescing, site in the object field available to an assistant and/or a surgeon, an image, in particular of the fluorescence phenomenon, acquired by the video imaging unit can be injectable via an image injection beam path into an assistant's observation beam path and/or into the main observation beam path of the surgical video stereomicroscope. This injection can occur according to the present invention into only one of the partial observation beam paths (right or left), or into both, monoscopically or stereoscopically. The injection can occur, if applicable, with one specific depiction (e.g. emission phenomenon only, in the NIR light wavelength region) for the one partial observation beam path (e.g. left), and with another specific depiction (e.g. emission phenomenon in the NIR light wavelength region, contrasted with blue excitation light) for the other.

This type of differing depiction can be brought about on the one hand by way of corresponding observation filters in the respective partial video observation beam path, which cause the different light wavelength regions in the different partial observation beam paths to be imaged differently. They could, however, optionally also be filtered out electronically. What is critical according to the present invention is that because of its elevated spectral sensitivity in the critical region, the video chip enables optimum acquisition of the usually rather weak image signals from the object field.

To make possible different depictions of the site of interest in the object field simultaneously, a first sub-region of the video imaging unit can thus have a higher spectral sensitivity in a first light wavelength region emitted or reflected from the excited site of interest in the object field, and a second region of the video imaging unit can have a higher sensitivity in a second light wavelength region emitted or reflected from the excited site of interest in the object field, so that the spectral sensitivity of the second region of the video imaging unit in a second light wavelength region emitted from the excited site of interest in the object field is elevated as compared with the first region of the video imaging unit. This can be implemented preferably with a single unitary video chip or, as is conventional, the stereoscopic left and right partial video observation beam paths can each have, in their image planes, a monoscopic video chip having the different spectral sensitivities as indicated. What is critical in this exemplifying embodiment is that a different spectral sensitivity is allocated to each partial video observation beam path, so that observation in each of the partial video beam paths results in respectively different image/color information or different intensities of specific light wavelength regions. For example, the video chip could have a high spectral sensitivity in the blue region in the left partial video observation beam path, and therefore be capable of imaging, for example, blue reflected light with particularly high intensity (so that even weak excitation light, for example, generates a strong video signal that thus appears bright when injected for the observer).

On the other hand, the video chip in the right partial video observation beam path could exhibit, for example, particularly high sensitivity to red emitted light, so that even weak fluorescence emission light yields a strong video signal and the weak fluorescence phenomenon appears bright. The result would be that an observer for whom the images of the video chip or chips were reproduced on a display would perceive, in one stereoscopic observation beam path, both good background illumination and a strong emitted light, both of which would moreover contrast well with one another. Similarly advantageous effects could be achieved with the invention using a wide variety of light wavelength regions, for example for IR or UV observation of object fields.

A refinement of the invention can, however, also be embodied in such a way that different spectral sensitivities are provided pixel-by-pixel within a partial image. The pixels could, for example, be subdivided in checkerboard fashion, such that on the straight sides, respectively adjacent pixels each have a different sensitivity. In electronic terms, in accordance with this refinement of the invention, particularly good light efficiency could thus be achieved with a single acquired image (although then with reduced resolution) both in one light wavelength region and in a region different therefrom. In terms of depiction on a display, not only could a distinction therefore be made between a right and a left partial image, but different spectral sensitivities within one partial image could also be emphasized. With a configuration of this kind it would be possible to acquire and depict stereoscopic images of high light intensity and sensitivity in different spectral regions using one and the same apparatus. A checkerboard configuration of this kind having different spectral sensitivities can also be used advantageously in other applications, independently of the other features disclosed. The disclosure in this regard thus offers priority protection for a novel video chip of this kind. The conventional configuration (RGB structure) of color video imaging units of video chips, with the corresponding different color sensitivities of the individual RGB pixels, is not encompassed by this novel video chip for lack of novelty. What is at issue according to the present invention is the aforementioned different spectral sensitivities in the special-illumination region and in the emitted light region, and not those that serve merely for conventional color imaging.

Preferred image reproduction can be achieved by the fact that the special-illumination surgical video stereomicroscope is set up, by means of a unitary display, to inject an image acquired by the first region (e.g. left region) of the video imaging unit, and an image acquired by the second region (e.g. right region) of the video imaging unit, simultaneously into at least one visual observation output, overlaid either stereoscopically or monoscopically.

According to an embodiment of the invention, a three-dimensional depiction of the acquired fluorescence images can be achieved in simple fashion in that the video imaging unit comprises a video camera having a unitary video chip, to each of whose two halves a partial video observation beam path is allocated; and that a likewise unitary display, to whose left and right image halves a respective left and right observation beam path is respectively allocated, is used for reproduction; or that a conventional stereo video camera having video chips modified according to the present invention serves as an imaging unit, the stereoscopic image of which is depicted (as is known per se) by being injected into a stereoscopic observation beam path, or on a 3D display.

The present invention may be embodied as a special-illumination surgical video stereomicroscope for detecting and assisting the treatment of areas of a specimen in an object field, preferably having a first white-light surgical microscope illumination device having a light source that irradiates the object field with white light at least during operational service, and selectably in a special light wavelength region during observational service. The stereomicroscope may have an observation beam path for guiding the light radiating from the specimen in the object field, and at least one stereoscopic video observation beam path having at least one first observation filter device in the video observation beam path, which device is, in the utilization state, principally entirely transparent in the emitted light wavelength region (a fluorescent light wavelength region, in the case of a fluorescence technique), and may optionally be partly transparent in the special light wavelength region (an excitation light wavelength region, in the case of a fluorescence technique). The stereoscopic video observation beam path may have a photoelectronic video imaging unit that is coupled to a video reproduction unit which is capable of presenting video images from the video imaging unit in the observation beam path to an observer by means of data injection.

### BRIEF DESCRIPTION OF THE DRAWINGS

The invention, together with further advantages, will be further explained below with reference to some non-limiting exemplifying embodiments that are depicted symbolically in the drawings, in which, schematically:

FIG. 1 shows a first variant of a surgical video stereomicroscope according to the present invention;

FIG. 2 shows a second variant of a surgical video stereomicroscope according to the present invention; and

FIG. 3 shows in detail a video imaging unit, together with evaluation electronics and a display, of the surgical video stereomicroscope of FIG. 1 and FIG. 2.

### DEFINITIONS OF TERMS

The definitions of certain important terms and functions are explained below.

A white light surgical microscope illumination device is known to one skilled in the art because it is used in a wide variety of surgical microscopes. It covers at least the entire spectrum of white light, since it is used principally to illuminate the surgical field and is intended to provide there, as a rule, the most faithful illumination possible during an operation. The subject matter embraced by the term “illumination device” of course also includes at least one (single) light source, but is not limited thereto and can also encompass multiple light sources. The white light surgical microscope illumination device can also comprise further subject matter such as light-guiding components, protective filters (e.g. IR or UV filters or the like). The particular illumination device used is not, in principle, essential in terms of the invention. For example, the invention can also function with normal operating-room illumination, and in extreme cases even with daylight. For this reason it is not obligatory for the invention, but is generally to be assumed, that the special-illumination surgical video stereomicroscope comprises a separate surgical microscope illumination device. Such an illumination device will, however, generally be present so that normal operations (not supported by special illumination, e.g. by fluorescence and/or video) can also be carried out. What ultimately matters in terms of the invention is the fact that illuminating light from any point (including from nature) is delivered onto a surgical field so that the latter is illuminated and/or excited to produce effects, e.g. fluorescence.

A special light wavelength region is understood as a light wavelength region that produces special observation effects on a specimen in the object field; these can be, in particular, fluorescence, autofluorescence, stimulated emission, and false-color illumination, etc. The special illumination also does not necessarily need to derive from the aforesaid white light surgical microscope illumination device, but could also, in the context of the invention, be made available in a manner known per se by a further light source or illumination device.

In this application, the term “radiate” encompasses both “reflect” and “emit” in every case (the latter in the case of fluorescence or stimulated emission).

In the operational state, the light of the optional illumination device lies in a regulatable spectral region by the fact that it possesses at least one selectably introducible working filter (e.g. illumination filter or excitation filter for fluorescence excitation) (the limiting, concretizing terms “working filter” and “excitation filter,” as well as “excitation,” will be discussed later) and is directable toward a specimen to be viewed or onto the object field. Video surgical stereomicroscopes that are embodied, for example, as fluorescence video surgical stereomicroscopes constitute a relatively new species of surgical microscopes that were created following the development of corresponding fluorescence-generating medications in the recent past (going back to, for example, 1962; Kleinsasser laryngoscopy of laryngeal tumors). They give the surgeon the capability of treating patients more effectively in the context of specific procedures, such as tumor operations or angiographic procedures. Body tissues that until then had been concealed from the surgeon or were difficult to recognize are made more visible in the object field thanks to the fluorescence phenomenon.

As also expressed by the expanded general term special-illumination surgical video stereomicroscopy, and as is entirely clear to anyone skilled in the art, such surgical microscopes must be equipped both with equipment for the procedure and with equipment for special-illumination microscopy (fluorescence microscopy, in the case of the fluorescence technique), and also for stereomicroscopy, in order for it to be suitable for serving the purposes of special-illumination surgical video stereomicroscopy.

This species of video surgical stereomicroscopes requires specific properties known to one skilled in the art, and specific constituents of the microscope which make said properties possible. Those pertinent to conventional fluorescence microscopy (which already existed long before the creation of surgical fluorescence stereomicroscopes) are:
an excitation light source or excitation illumination device (formerly, for example, often a mercury vapor lamp),
an excitation filter to improve the quality of the excitation light (spectral filtering out of those light wavelength regions that do not contribute particularly well, or at all, to fluorescence excitation), and a blocking filter or observation filter in the observation beam path of the surgical fluorescence stereomicroscope. The latter serves in turn to filter out the excitation light to a greater or lesser extent, since little or none of it is after all intended in principle to be seen, while the emission of the fluorescence phenomenon needs to be seen as well as possible. Depending on the nature of the excitation light, it is in some circumstances, with extended exposure, in fact hazardous to the observer's eyes (e.g. UV). The observation filter serves in particular, however, to prevent the excitation light from outshining the often weak fluorescence phenomena and thereby negatively affecting the quality and, above all, the intensity of the observed fluorescence. The observation filter is therefore in some cases also referred to as a “blocking filter.”

The present invention deals with a particular embodiment of a surgical stereomicroscope of this kind that is likewise, but not obligatorily, suitable for fluorescence microscopy. The intention in the context of the invention is that special-illumination depictions (special-illumination surgical microscopy) in particular, for example false-color depictions, spectrally selective contrast depictions, etc., can be utilized alternatively to fluorescence microscopy with the aid of video technology. In this context, in addition or as an alternative to the visual observation beam path, a video observation beam path is provided which begins at the object field and ends at a video imaging unit. Reference is made in this regard to FIG. 4 and the relevant figure description of the Applicant's patent application L239PDE/P3073, and its counterpart U.S. application Ser. No. ______ filed ______, which symbolically depicts a video observation beam path of this kind, a sensor (11) being arranged at the end of the observation beam path. The disclosure of L239PDE/P3073 and its counterpart U.S. application Ser. No. ______ filed ______, with regard to its FIG. 4 and the relevant figure description, is herewith incorporated by reference. The observation beam path depicted in this FIG. 4 corresponds to a video observation beam path for purposes of the invention in that it is terminated in an image plane with an image sensor (11). It is worth noting that in the case of both the present invention and FIG. 4 as cited, a stereoscopic beam path is present, having two separate monoscopic beam paths that overlap in the drawing plane of the aforementioned FIG. 4. The observation filter provided there is at least partly transparent to the excitation wavelengths. Not only the emitted light of the fluorescence phenomenon, but also the excitation light reflected from the specimen in the object field, is therefore visible there in any case in the observation beam path. The observation filter according to L239PDE/P3073 (U.S. application Ser. No. ______) is thus not a complete blocking filter against excitation light.

This particular embodiment of an observation filter serves to make visible simultaneously to the observer or surgeon both non-excited, non-fluorescing tissue and excited, fluorescing tissue in the object field, so that these tissues can contrast with one another in terms of color, since the fluorescence phenomenon (emitted light) has in principle a different color (light wavelength) from the excitation light. In the case of the other forms of special-illumination microscopy, the fluorescence phenomena and fluorescence mechanisms mentioned herein are to be mentally replaced analogously with the respective effects of the respective special illumination.

A working filter (excitation filter in connection with fluorescence) is a filter that allows exclusively or principally special wavelengths to pass, and is arranged as necessary in the illumination beam path (also called the “excitation beam path” in the case of fluorescence technology) if the special-observation phenomena (e.g. the fluorescence phenomena) are to be excited or optimized.

An observation filter is (in connection with fluorescence) a filter that substantially allows transmission only of the light (which is respectively in a very different light wavelength region from the excitation light in the case of fluorescence) radiated from the specimen (the fluorescing substance/tissue, in the case of fluorescence) that is reacting to the special illumination in the object field, and absorbs all other light wavelengths, thereby enabling optimized optoelectronic conversion, at the photoelectronic sensors of the video chip, in the region of the fluorescent emitted light of the fluorescence phenomenon. It is arranged, as necessary, directly in front of the video chip, or integrated into it, in the video observation beam path. It is thus, in connection with a video chip, a filter that substantially allows transmission only of the light (which in the case of fluorescence is in each case in a very different light wavelength region from the excitation light) radiated from the specially-illuminated area (e.g. from the fluorescing substrate or fluorescing tissue) in the object field, and thus enables optimized observation of the special-illumination or fluorescence phenomenon.

A video chip encompasses photoelectronic sensors that, when struck by light, convert it into electronic image signals that are assembled into a video frame (electronically organized, spatially reproducible grouping of image signals). A video chip is to be understood for purposes of the invention as an image acquisition unit or image converter chip in the most general form. What is critical according to the present invention is that with it, a visual image signal can be converted into correlated electronic image signals that, subsequently thereto, can be depicted again to a user via a display.

For purposes of the invention, a video frame is thus an electronically coded individual complete recording of an image of the object field, from a series of successive images.

An illumination filter is a filter that serves to improve the illumination light for purposes of (non-special, non-excitation) illumination of an object field. Illumination filters are therefore, in the overall context, filters that, if applicable, do the opposite of a working filter or excitation filter and attenuate or filter out from a light spectrum, for example, those spectral regions that serve more for special illumination or fluorescence excitation and are disproportionately available because of the design of the illumination device but themselves contribute little in terms of illumination or might have a troublesome effect in that context. Every illumination filter in every illumination device serves ultimately to optimize the illumination light. In the present case, illumination filters can thus be placed as applicable, for the case of surgery, in front of the illumination device or light source, whereas in the case of excitation, excitation filters appear in their stead. A typical illumination filter is, for example, a white light illumination filter (often referred to simply as a “white light filter”). It is designed so that from the overall spectrum of the light available from the respective illumination device, the light allowed to pass onto the object field is as white as possible (optimized mixture of all spectral colors or light wavelengths). Depending on the configuration of the surgical fluorescence stereomicroscope, an illumination filter can be removable or can be arranged fixedly in the illumination beam path. If the illumination device encompasses, for example, two light sources (one for excitation light and one for white light), the illumination filter can then be permanently arranged in front of the white light source. If there is only one light source, however, the illumination filter can also be exchangeable with the excitation filter. Not to be overlooked is the fact that even in cases where an illumination filter is used (in particular for white light), the light present in the illumination beam path contains fluorescence excitation wavelengths and thereby excites fluorescence in any photosensitizers that are present. Without special devices, namely observation filters, these fluorescence phenomena cannot as a rule be perceived visually, since they are greatly outshone by the white light reflected in the object field. The reason for this is that the emitted light intensity of the fluorescence phenomenon is much lower than the illumination intensity necessary to excite fluorescence. Conventional surgical fluorescence microscopes thus need to resort to observation filters in order to make effective use of fluorescence phenomena.

A fluorescence microscope is thus a microscope that is suitable for viewing fluorescence phenomena and comprises for that purpose, in particular, an excitation light source or excitation illumination device having an excitation filter and an observation filter in the beam path.

A surgical microscope is, on the other hand, a microscope having relatively low magnification, in which the stereoscopic beam paths generate a three-dimensional image, and having a surgical microscope illumination system for bright, maximally natural illumination (usually white light) of the object field.

A stereomicroscope is a microscope having a stereoscopic beam path from the main objective to the eyepieces. It allows the observer to view the object field in three dimensions, and thus to recognize three-dimensional structures. In connection with surgical video microscopy, this term also encompasses the three-dimensional depiction of (or ability to depict) images, acquired in the video observation beam path three-dimensionally (a left and a right video observation beam path), on a stereo display capable of three-dimensional depiction.

A video microscope, on the other hand, is a microscope that can dispense with a visual beam path because the object field is visually depicted to a user on a display. Video microscopes are often integrated into conventional surgical microscopes in the form of video beam paths, in order to obtain additional information or in order to show the events in the surgical field to several observers simultaneously, or also simply in order to record surgical procedures. Many of these known surgical video microscopes also provide feedback for automatic control of the surgical microscope or to inform the user better, for example by overlaying for him or her image information from the video microscope that is unavailable by visual observation.

It is known that conventional CCD video chips react, for example, outstandingly to IR (infrared) light, whereas the human eye cannot perceive infrared. It is thus possible, for example, to acquire infrared image information via the imaging unit of the video microscope and inject it for the user by image injection via a beam splitter, in alternative or superimposed fashion, into the visual observation beam path. The designation “video” encompasses, in the context of the invention, all conceivable image signal technologies that, by photoelectronic conversion, convert image information obtained from a beam path into electronic signals, and convert them in turn (e.g. via a display) into visually perceptible image data. It is thus not limited to video technology with regard to electronic film recording technology, but also encompasses static recording of static images (photos), and also electronic recording, processing, and depiction of only partial image information, using a wide variety of respectively available image/film recording technologies.

The nature (software or hardware) of the processing of the electronic image signals is secondary in terms of the invention. What is critical for the invention is the manner of acquisition (conversion of optical signals into electronic signals) and optionally the depiction (conversion of electronic signals into optical image data) for the user or users.

In order to make information from the object field additionally available to an assistant, surgical stereomicroscopes often encompass additional observation beam paths (assistant's output) that either are branched off from the existing observation beam path using beam splitters, mirrors, or prisms, or possess a separate stereoscopic observation beam path and are arranged with respect to the actual observation beam path of the main user with a rotation of, for example, 90° with respect to the main objective about its center axis. An assistant thus sees what the surgeon is doing, and in the second case sees it in fact from a different perspective (rotated 90 degrees) as compared with the main observer or surgeon. The assistant's output is often also embodied as a video observation beam path.

Both the main observation beam path and the assistant's observation beam path often have, via beam splitters (beam splitters, prisms, or the like), the capability of injecting information into the observation beam path in order to provide the main observer and the assistant with additional information without requiring them to look away from the microscope.

A stereo display is to be understood as a display that conveys to a user a three-dimensional image generated by video technology. It can be a flat two-dimensional display (e.g. an LCD display) having a lenticular screen in front of it, or having a time-modulated stereo depiction using shutter glasses or a color-coded 3D depiction. It also encompasses, however, those apparatuses that monoscopically reproduce the left and right partial images and inject them, for example, into the observation beam path of the surgical microscope, or stereoscopically depict the 3D image for the user in head-up displays or in split displays (see US-A1-2009/0190209, FIG. 6) or the like.

A regulatable spectral region is to be understood as a region that can be limited (and thus, depending on the selection of the excitation filter and/or observation filter and/or the video imaging unit, regulated) in terms of its spectral properties by the excitation filter and/or the observation filter, on the one hand by selecting and/or activating excitation filters and/or observation filters and/or video imaging units, and on the other hand by using or activating, or removing or deactivating, said filters or imaging units.

### DETAILED DESCRIPTION OF THE INVENTION

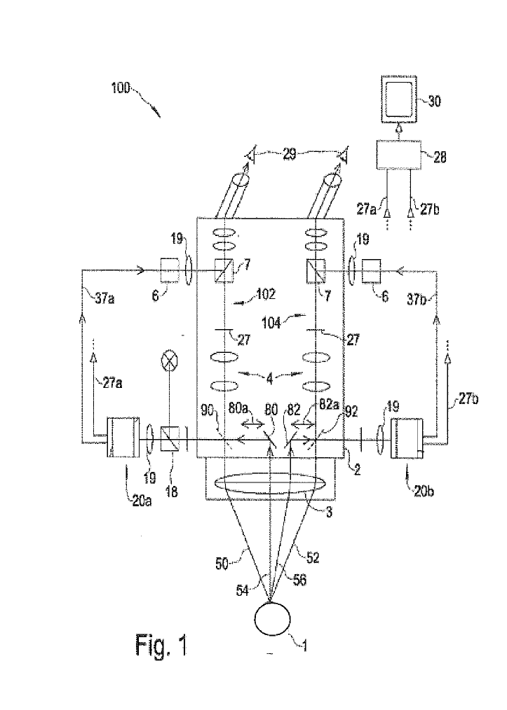

Video surgical microscope 100 according to the present invention that is depicted in FIG. 1 is embodied as a stereomicroscope and comprises two video imaging units 20a, 20b. Each of the video imaging units 20a, 20b can be, for example, a CCD or CMOS camera or a CCD or CMOS video chip, or the like. The spectral sensitivity of the video imaging unit or video chip is, according to the present invention, designed for a specific spectral region or for specific wavelengths that correspond to those expected, for example in terms of emitted fluorescence radiation, from a specially illuminated site of interest being viewed in object field or specimen 1. Excitation of the site of interest in object field 1 is accomplished, if applicable, using an illumination device (not depicted here) known per se, or also simply by means of ambient light from, for example, a conventional operating-room lamp.

An observation of specimen 1 after corresponding illumination or excitation is possible by means of video imaging units 20a, 20b, as will be explained below.

Observation beam paths 54, 56 proceeding from specimen 1, after passing through main objective 3 in microscope housing 2, strike deflection elements 80 and 82, respectively. Observation beam path 54 is directed via deflection element 80, which is preferably embodied as a prism or mirror, into first video imaging unit 20a. A beam splitter element 18 and an image-forming system 19 (depicted for the sake of simplicity as a lens) are embodied between deflection element 80 and stereo imaging unit 20a. The function of beam splitter element 18 will be explained later.

Analogously thereto, second video imaging unit 20b is impinged upon by the further observation beam path 56 proceeding from specimen 1, which beam path is deflected by means of a further deflection element 82. An image-forming system 19 (once again depicted in simplified fashion as a lens) can likewise be provided between deflection element 82, which once again is embodied preferably as a prism or mirror, and second video imaging unit 20b.

The electronic images generated by the two video imaging units 20a, 20b can be digitized and delivered via leads 27a, 27b to a computer 28, where they are processable into a stereoscopic 3D image depictable on a display 30.

If the video chip in the video imaging unit is unitary, electronic signal processing is then very simple, since the electronic system acquires the stereo image as a single video frame. In the latter, each image point is allocated to a corresponding image point in a display, so that when depicted on a display, the image (right and left partial image) from the image plane is essentially depicted in enlarged fashion.

Alternatively or in addition to observation via observation beam paths 102, 104 of microscope 100, specimen 1 to be observed can thus be viewed stereoscopically by observer 29 on display 30, provided he or she is allowed a stereoscopic view of the display. This is brought about most easily by directing (as already indicated in US-A1-2009/0190209, FIG. 6) a stereoscopic observation beam path onto the display, so that the left part of the display is allocated to the left eye, and the right part of the display to the right eye.

Alternatively or in addition to this stereoscopic image processing and depiction on a display by means of computer 28, the images generated by the two video imaging units 20a, 20b can also be injected directly and without intermediary into observation beam paths 102, 104. This makes possible an overlay of the images occurring in observation beam paths 102, 104 with the images generated by video imaging units 20a, 20b. It is of course also possible, using the same apparatus (and in a manner known per se), to inject other image material, for example from the computer or from other diagnostic units, for improved diagnosis or therapy.

This overlay advantageously occurs by means of overlay devices 6, 7 to which the respective signals and images of video imaging units 20a, 20b are delivered via leads 37a, 37b. These overlay devices each comprise an image processing device 6 and a beam splitter 7 positioned in observation beam paths 102, 104 and beam paths 50, 52, respectively. Image processing devices 6 each comprise a depicting display that transfers the respective images to be displayed, via further image-forming systems 19 (once again depicted symbolically as a lens), to beam splitter 7. Because this overlay occurs, when viewed from objective 1 or main objective 3, behind zoom system 4, the actual magnification that results from the zoom system and is experienced by beam paths 50, 52 must be taken into account in image processing devices 6. Zoom system 4 has for this purpose sensors that sense the current magnification of the zoom system and thus influence how image processing devices 6 are regulated.

It is thus evident from FIG. 1 that the partial visual observation beam paths 50 and 52, and partial video observation beam paths 54 and 56, can each respectively have a different magnification, since partial observation beam paths 50 and 52 pass through zoom 4 but partial video observation beam paths 54 and 56 do not. In overlay devices 6, 7 these beam paths (or images generated from them) can nevertheless be overlaid onto one another correctly in terms of size by, usefully, also compensating for these magnification differences in image processing devices 6, electronically or by way of a correspondingly (preferably computer-) controlled image-forming optical system.

Several alternative possibilities present themselves in this connection. For example, it is conceivable to minimize the angle between the respective beam paths 50 and 54, and 52 and 56, as much as possible, in order to minimize the distances between the respective deflection elements and the beam paths 50, 52 passing through zoom system 4. For this purpose, deflection devices 80, 82 can also be embodied displaceably perpendicular to beam paths 50, 52 that pass through zoom system 4, as indicated by double arrows 80a, 82a.

It is likewise advantageously possible to inject the images generated by video imaging units 20a, 20b into beam paths 50, 52 below the zoom system, i.e. for example between main objective 3 and zoom system 4. In this case, computational compensation for the magnification of zoom system 4 can be omitted.

It is further evident from FIG. 1 that the observation angles of observation beam paths 50 and 54, and 52 and 56, are different in each case. Because these beam paths, or images generated from them, are overlaid on one another in overlay devices 6, 7, these angle differences or positional differences are usefully compensated for by displacement of mirrors 80, 82 along the arrows into positions 90, 92.

A further possibility for positioning deflection elements or beam splitter devices for selectable impingement onto observation beam paths 102, 104 and/or video imaging units 20, 20b is depicted with dashed lines in FIG. 1 and is labeled 90, 92.

This can involve beam splitter elements 90, 92 that are insertable into visual observation beam paths 102, 104 in order to make available a video observation beam path through observation beam paths 102, 104 and/or an impingement upon video imaging units 20a, 20b. Beam splitter elements 90, 92 are embodied, for example, as semitransparent mirrors that divide beam paths 50 and 52, respectively, into partial beam paths through zoom system 4 and through video imaging units 20a, 20b. This type of approach has the advantage, as compared with the provision of mirrors 80, 82, that the observation angle for the beam paths through the zoom system and through video imaging units 20a, 20b, respectively, is the same from the outset.

Beam splitter elements 90, 92 can furthermore, for example, also be embodied as micromirror arrays whose individual micromirrors are positionable so that both complete reflectance and complete transmittance of beam splitter elements 90, 92 can be established. With complete reflectance, beam paths 50, 52 are deflected in their entirety into the respective stereo video imaging units 20a, 20b. With complete transmittance, beam paths 50, 52 are completely directed into zoom system 4 and into the optical components subsequent to it.

In the context of the invention, beam splitter elements 90, 92 can also themselves be coated so that, like an observation filter, they act in spectrally selective fashion and, for example, are transmissive for white light in a relatively narrow light wave region and on the other hand are reflective for UV and UV-vicinity light wavelength regions and/or for NIR or IR regions. The high sensitivity according to the present invention of the video chips could be brought about in this fashion, since they are then impinged upon in practice not with white light but instead exclusively with the UV and UV-vicinity light wavelength regions and/or NIR or IR light wavelength regions. They can also, correspondingly, be embodied in optimized fashion for those light wavelength region, or the video signal is maximal in those light wavelength regions.

It is likewise conceivable to provide deflection elements 80, 82 and beam splitter elements 90, 92 together in one special-illumination surgical video stereomicroscope, and to use them alternative or also simultaneously.

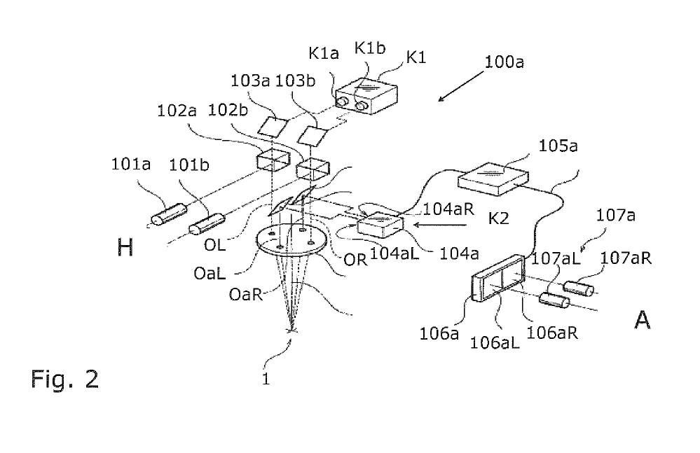

FIG. 2 schematically depicts a further exemplifying embodiment of a surgical video stereomicroscope 100a according to the present invention. Main surgeon H looks through two eyepieces 101a, 101b directly into the two partial visual observation beam paths of surgical video stereomicroscope 100a. A video imaging unit, having a unitary video chip to each of whose two halves a partial video observation beam path is allocated, or a stereo video camera K1, simultaneously acquires the stereoscopic microscope image. In this context, a left and a right object beam OL, OR proceeding from the site of interest in object field 1 can be injected via beam splitters 102a, 102b and deflection mirrors 103a, 103b into two inputs K1a, K1b of video imaging unit K1.

A further video imaging unit—a video camera having a unitary video chip to each of whose two halves a partial video observation beam path is allocated, or a stereo video camera K2—acquires the 90-degree-rotated microscope image and provides it to assistant A. Video imaging unit K2 can comprise a video chip 104a whose spectral sensitivity is designed in accordance with the fluorescence conditions of the site of interest in object field 1. Be it noted at this juncture, however, that video imaging unit K1 and video imaging unit K2 can also be embodied similarly. Object beams OaL, OaR that are deflected via deflection mirrors onto video imaging unit K2 can be acquired on video chip 104a on left part 104aL and on right part 104aR, and converted into electronic video signals. The video signals acquired by video chip 104a can be forwarded to a controller 105a that carries out, as applicable, a reprocessing of the images acquired on the left 104aL and right sides 104aR, respectively, of video chip 104a, said images nevertheless first being electronically processed as a single image (made up of two halves). The data of the (reprocessed or calculated) images can be transferred from controller 105a via a lead 108a to a display 106a. Reproduction on display 106a for each eye of assistant A can occur in sub-regions 106aL, 106aR of display 106a in accordance with the images acquired in left 104aL and right part 104aR of video chip 104. Assistant A can view the individual sub-regions 106aL, 106aR of display 106a through eyepiece 107a or through the individual display observation beam paths 107aL, 107bR of eyepiece 107a.

As already indicated above, the spectral sensitivity of video chip 104a can be designed so that both parts 104aL and 104aR are together designed for a fluorescence radiation that is expected or possible following an excitation of the site of interest in object field 1, for example for 400 nm or 800 nm.

This can occur either by corresponding filtration by means of filters F1, F2 directly in front of video chip 104a, or by means of spectrally selective beam splitters, as indicated above, or by special doping of video chip 104a itself, such that simultaneously, in order to improve contrast, the sensitivity in the unneeded visual spectral region can be reduced. CCD video chips themselves are to be used according to the present invention if they are sensitive to a specific color. In order to achieve the desired spectral tuning in improved fashion, it is thus possible additionally to incorporate corresponding observation filters between an optionally provided image-forming optical system of the video imaging unit and the CCD video chip of video imaging unit 104a. As an alternative to the use of observation filters, the desired spectral sensitivity can also, as already mentioned above, be achieved by way of a corresponding doping (known per se) of video chip 104a, which if applicable can even be equipped to be electronically modifiable. One skilled in the art of manufacturing video chips, having learned the teaching of this invention, is aware of ways and means of manufacturing corresponding video chips.

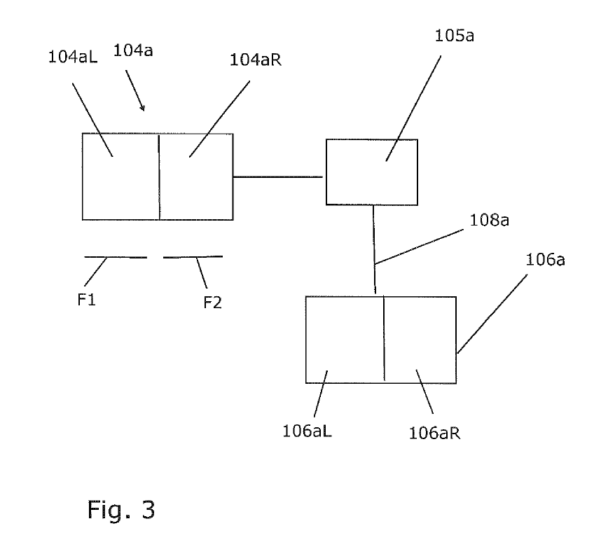

It is further possible, in accordance with FIG. 3, to design the desired spectral sensitivity of video imaging unit 104a in such a way that, for example, region 104aL is effective e.g. for 400 nm, and part 104aR e.g. for 800 nm. In order to implement different spectral sensitivities for parts 104aL and 104aR it is also possible to use two mutually independent CCD or CMOS video chips that have corresponding filters in front of them and/or that exhibit correspondingly different dopings. Even with such a configuration, however, the two video chips advantageously would be read out as a single undivided video chip, or at least integrated, immediately after being read out, into one video frame, so that subsequent video data processing is simplified and depiction on a unitary display is readily possible without further actions.

When video imaging unit 104a has a different spectral effectiveness, a 400-nm and an 800-nm depiction can be achieved simultaneously, and can be injected into the special-illumination surgical video stereomicroscope for the surgeon, simultaneously with or alternatively to his or her visual image. This is accomplished in control unit 105a (for example, a correspondingly programmed signal processor) that is designed specifically for this advantageous embodiment. This creates on the one hand the possibility of generating, for example, a stereoscopic 400-nm or, for example, a stereoscopic 800-nm image pair, or simultaneously showing the observer an e.g. 400-nm or e.g. 800-nm image in each eye. Using corresponding circuitry in module 105a, so-called “picture-in-picture” images, i.e. e.g. 400-nm and e.g. 800-nm images, can also be generated on display 106 in an image channel L or R.

The data of the fluorescence radiation, recorded by the stereo video imaging unit, of the site of interest in the object field are prepared in a data processing unit and can, if necessary, additionally be injected as a false-color image for the surgeon into the special-illumination surgical video stereomicroscope, using known methods (see FIG. 1).

Be it noted also at this juncture that the aforesaid spectral regions are merely exemplifying and can of course be selected differently, depending on the actual fluorescence phenomenon.

It is preferred that the electronic processed images of inherently invisible light wavelengths, which can now be acquired particularly well because of the spectral sensitivity of the video chip, be depicted using false colors. For example, the 400-nm color could be depicted as 500 nm, and the 800-nm color as 700 nm.

Further embodiments and details of the invention are evident from the Claims, which together with the List of Reference Characters and the Figures contribute to the disclosure of the descriptive introduction.

In conclusion, the essence of the invention is to seen in the fact that instead of efforts to improve excitation illumination using special excitation filters, special-illumination devices, etc., the improvement is now achieved on the image acquisition side with the aid of the video chips according to the present invention.

The invention is of course not limited to making do with simple illumination devices or in fact with none at all; on the contrary, a combination of good illumination or excitation technology together with the invention can result in even further improved results. We refer explicitly to the Applicant's surgical stereomicroscope technology, which has been brought to market under the designation FL400 and FL800. Reference is likewise explicitly made to the Applicant's patent applications U.S. application Ser. No. ______ filed ______ (corresponding to L239PDE/P3073) and U.S. Pat. No. 7,649,685 (corresponding to EP-A1-1 691 229), the entire contents of which is incorporated herein by reference.

A special-illumination surgical video stereomicroscope according to the present invention is usable essentially universally, improves a surgeon's diagnostic capability, and ultimately serves the purpose of improved patient treatment. In addition to conventional surgical fluorescence microscope techniques, it also allows improved perception of autofluorescence effects, false-color depictions, etc., requires less special-illumination or excitation light, and optionally allows elimination of a complex blocking filter in the observation beam path and, if applicable, complex excitation filters in the excitation illumination beam path. Thanks to high-sensitivity video chips in the IR region, thermal radiation from the tissue, which hitherto could not be visualized in a surgical microscope itself, can thus also be sensed selectively for the right and left partial beam path with monoscopic depiction.

Because, in a particular exemplifying embodiment of the invention, one half of the video chip is configurable to be selectably (switchably) of different or identical sensitivity to the other half of the chip, it is possible to switch over between monoscopic viewing in one partial beam path and stereoscopic viewing in both partial beam paths.

In the case of stereoscopic viewing of a specific specimen location, care must be taken that when the video chip halves are selected to be spectrally different, the image information cannot be perceived stereoscopically by an observer. The inherently stereoscopic image information is therefore broken down for the observer into two differently colored monoscopic partial images, so that the observer can perceive different monoscopic images with the left and the right eye, respectively. This can be very significant for certain diagnostic questions. If he or she desires a stereoscopic view, however, he or she can, according to the present invention, apply the same spectral property to both partial beam paths or both halves of the chip.

Although the present invention has been described with respect to one or more particular embodiments, it will be understood that other embodiments of the present invention may be made without departing from the spirit and scope of the present invention.

### LIST OF REFERENCE CHARACTERS

Specimen 1
Microscope housing 2
Main objective 3
Zoom system 4
Overlay device 6
Overlay device 7
Beam splitter element 18
Image-forming system 19
Video imaging unit 20a
Video imaging unit 20b
Lead 27a
Lead 27b
Computer 28
Observer 29
Display (monitor, optionally 3D) 30
Lead 37a
Lead 37b
Partial observation beam path 50
Partial observation beam path 52
Partial video observation beam path, in particular for fluorescence emission radiation 54
Partial video observation beam path, in particular for fluorescence emission radiation 56
Deflection element 80
Deflection element 82
Beam splitter element 90
Beam splitter element 92
Special-illumination surgical video stereomicroscope 100
Special-illumination surgical video stereomicroscope 100a
Eyepiece 101a
Eyepiece 101b
Partial visual observation beam path 102
Beam splitter 102a
Beam splitter 102b
Deflection minor 103a
Deflection minor 103b
Partial visual observation beam path 104
Video chip 104a
Left part 104aL
Right part 104aR
Controller 105a
Display 106a
Sub-region 106aL
Sub-region 106aR
Eyepiece 107a
Display observation beam path, left 107aL
Display observation beam path, right 107aR
Lead 108a
Object beam, right OaR
Object beam, left OaL
Assistant A
Main surgeon H
Video camera having a unitary video chip to each of whose two halves a partial video observation beam path is allocated, or stereo video camera K1
Input, right K1a
Input, left K1b
Video camera having a unitary video chip to each of whose two halves a partial video observation beam path is allocated, or stereo video camera K2
Observation filter F1
Observation filter F2

What is claimed is:

1. A special-illumination surgical video stereomicroscope for observation of a specimen under special illumination, comprising:
at least one video stereo observation beam path having a stereoscopic partial beam pair made up of two partial beam paths;
a video imaging unit including at least one video chip for acquisition of a stereoscopic video image, the at least one video chip having two chip portions, wherein each of the two chip portions includes photoelectronic sensors;
wherein a different one of the two partial beam paths is allocated to each of the two chip portions; and
wherein a spectral sensitivity of one of the two chip portions differs from a spectral sensitivity of the other of the two chip portions.

2. The special-illumination surgical video stereomicroscope according to claim 1, wherein the special illumination is fluorescence excitation illumination and the specimen emits fluorescence emission radiation when excited by the special illumination, and one of the two chip portions has a higher spectral sensitivity in at least a light wavelength region of expected fluorescence emission radiation than in other light wavelength regions.

3. The special-illumination surgical video stereomicroscope according to claim 1, wherein the spectral sensitivity of at least one of the two chip portions can be changed, and both of the chip portions can be operated with the same spectral sensitivity.

4. The special-illumination surgical video stereomicroscope according to claim 2, wherein the one chip portion has a higher spectral sensitivity in all light wavelength regions of expected emission radiation, and reduced spectral sensitivity in other light wavelength regions.

5. The special-illumination surgical video stereomicroscope according to claim 1, wherein the photoelectronic sensors of at least one of the two chip portions have an adjustable sensor sensitivity.

6. The special-illumination surgical video stereomicroscope according to claim 1, wherein at least one of the two chip portions is a CCD or CMOS video chip; and
wherein at least one observation filter or spectrally selective beam splitter is placed upstream from the at least one chip portion to allow at least one light wavelength region of expected fluorescence emission radiation to pass through unattenuated onto the photoelectronic sensors of the video chip and to simultaneously attenuate other light wavelength regions.

7. The special-illumination surgical video stereomicroscope according to claim 6, wherein in a fluorescence observation state, the photoelectronic sensors of the at least one chip portion are operated with maximum sensor sensitivity.

8. The special-illumination surgical video stereomicroscope according to claim 1, wherein the at least one video chip is a CCD or CMOS video chip, and the spectral sensitivity of a first of the two chip portions is modified by doping the photoelectronic sensors thereof.

9. The special-illumination surgical video stereomicroscope according to claim 1, wherein the at least one video chip is a single video chip.

10. The special-illumination surgical video stereomicroscope according to claim 1, wherein the stereoscopic video imaging unit comprises two video chips, each video chip being allocated to one of the two partial beam paths and being respectively read out in an acquired-image state in a corresponding video frame;
wherein each of the two video chips is allocated to a single two-part display;
wherein the two video frames are electronically integrated so that a left stereoscopic partial image is reproduced on a left part of the display, and a right partial is reproduced on a right part of the display; and
wherein stereoscopic 3D viewing results from a stereoscopic display observation beam path having a left partial display observation beam path and a right partial display observation beam path.

11. The microscope according to claim 10, wherein the video imaging unit is a stereo video camera, and the stereoscopic partial images are processed in separate video frames in the acquired-image state.

12. The special-illumination surgical video stereomicroscope according to claim 1, further comprising a main visual observation beam path, wherein a fluorescence image acquired by the video imaging unit is selectably stereoscopically or monoscopically insertable into the main visual observation beam path.

13. The special-illumination surgical video stereomicroscope according to claim 12, wherein the fluorescence image acquired by the video imaging unit is overlaid with an optical viewing image in the main visual observation beam path.

14. The special-illumination surgical video stereomicroscope according to claim 1, further comprising an assistant's viewing output, wherein a fluorescence image acquired by the video imaging unit is selectably stereoscopically or monoscopically insertable into the assistant's viewing output.

15. The special-illumination surgical video stereomicroscope according to claim 2, wherein the specimen emits fluorescence emission radiation in a first light wavelength region and in a second light wavelength region different from the first wavelength region when excited by the special illumination, and wherein one of the two chip portions has a higher spectral sensitivity than the other of the two chip portions in the first light wavelength region emitted from an excited object, and the other of the two chip portions has a higher spectral sensitivity than the one of the two chip portions in the second light wavelength region emitted from an excited object, whereby each video frame generated from the at least one video chip comprises physically separate maximal electronic image information of two spectrally different fluorescence phenomena in an object field.

16. The special-illumination surgical video stereomicroscope according to claim 1, wherein a first of the two chip portions is sensitive to white light and a second of the two chip portions is sensitive to fluorescence emission light.

17. The special-illumination surgical video stereomicroscope according to claim 6, wherein a pair of observation filters are placed upstream from the at least one video chip, wherein the observation filters are exchangeable with observation filters having different wavelength transmission and attenuation properties.

18. The special-illumination surgical video stereomicroscope according to claim 17, wherein the observation filters are electromechanically selectable from a set of observation filters and insertable or removable.

19. The special-illumination surgical video stereomicroscope according to claim 17, wherein the observation filters in front of the video chip include displaceable microarray elements.

20. The special-illumination surgical video stereomicroscope according to claim 8, wherein the spectral sensitivity of the two chip portions is reversibly modifiable by means of electronic control signals that vary the doping.

21. The special-illumination surgical video stereomicroscope according to claim 1, further comprising two alternatively or simultaneously operable illumination devices for illuminating the specimen, a first of the two illumination devices being optimized to provide white light and a second of the two illumination devices being optimized to provide excitation light.
